(19) United States
(12) Patent Application Publication
(10) Pub. No.: US 2016/0318707 A1
(43) Pub. Date: Nov. 3, 2016

(54) Liquid Tight Roll-Off Vacuum Container

(71) Applicant: The Modern Group, Ltd., Beaumont, TX (US)

(72) Inventor: Gary R. Markham, Lumberton, TX (US)

(21) Appl. No.: 15/141,788

(22) Filed: Apr. 28, 2016

Related U.S. Application Data
(60) Provisional application No. 62/154,764, filed on Apr. 30, 2015.

(51) Int. Cl. B65D 88/12; B65G 63/00; B65D 88/02; B65D 90/00; B65D 88/72; B65D 90/10

(52) U.S. Cl. CPC B65D 88/129; B65D 88/72; B65D 90/10; B65D 88/027; B65D 90/008; B65G 63/004

(57) ABSTRACT

The disclosed invention relates to storage containers that may be transported by various intermodal means. The disclosed invention may be transported like any intermodal container. Additionally, the disclosed invention is capable of maintaining a vacuum seal when closed while maintaining intermodal functionality.

### PRIORITY/CROSS REFERENCE TO RELATED APPLICATION

This application claims priority to Provisional Patent Application No. U.S. 62/154,764 entitled “Liquid Tight Roll-Off Vacuum Container” by Gary R. Markham filed on Apr. 30, 2015. That application is incorporated by reference in its entirety.

### FIELD OF THE INVENTION

The field of invention is transportation containers.

### BACKGROUND OF THE INVENTION

Storage containers are used in many industries to hold waste products at a collection location to be later transported to a disposal site. An example of a place that generates waste products would include drilling sites for oil and gas wells. Storage containers in this example are transported to the drilling site, where they are decoupled from their transport vehicle (such as a roll off truck), or may stay on their transport vessel (such as a ship moored near an offshore oil platform).

When stationed at a waste collection location, the storage containers are filled with waste products to be disposed. Examples of these waste products can include, but are not limited to: sludge, cuttings, naturally occurring radioactive materials (NORM), drilling mud, fracturing liquids, fluids from environmental cleanup, water, brine, mixtures, suspensions, slurries, or materials in different phases. NORM is a particular concern for oil production as NORM is generated as a byproduct of drilling. As mud is pumped into the well, it returns filled with cuttings which include NORM. The cuttings are removed from the mud via onsite mechanisms (such as shale shakers), but the cuttings need to be stored for disposal. Depending on the number of steps in the transportation chain between collection and disposal, the cuttings may be transferred between multiple containers, resulting in delays and possible accidental release of the cuttings.

These storage containers may be filled in various methods. One method may be the use of a crane to place items into the container. Another example would include the use of an external pumping system to fill a container.

Once a storage container is filled, it needs to be transported. Conventions in the transportation industry necessitate standardization of containers to be transported by various means. Such storage containers that can be transported by various mechanisms are known as intermodal containers. One of these conventions for intermodal containers is the International Organization of Standards (ISO). ISO standards govern various design characteristics of a container, such as dimensions and how high the storage containers may be stacked. The containers must meet these specifications in order to be transported by existing ISO designed transportation mechanisms.

While there are ISO standards for shipping containers, the typical container used for the storage of cuttings may not conform to ISO standards. As a result, the storage containers used may be transportable by truck, but not by rail or ship. Transfer of the contents of the storage container to another transportation mechanism would necessitate the unloading of the storage container into a second storage container, adding steps to the transportation process. This process adds delay and expense to the transportation of waste products to a disposal site. There exists a need for a single container that is capable of collecting and containing such waste products while conforming to established intermodal mechanisms for transportation. The needed container could be described as a liquid tight roll-off vacuum (LTRV) container.

### SUMMARY

The disclosure describes an improved container known as an LTRV container 100. Various shortcomings, disadvantages, and problems of storage containers are addressed herein, which will be understood by reading and studying the following specification.

The LTRV container 100 facilitates the transportation of items in a container that may be vacuum sealed during transport. Unlike standard vacuum sealed containers, the LTRV container 100 may be used as an intermodal container and transported by multiples mechanisms. Further, it may be stored and stacked like other standard intermodal containers. The primary elements of the LTRV container 100 are the container frame 110 and the tank 112.

The LTRV container 100 may be loaded in any means known to those skilled in the art, including vacuum loading. The LTRV container 100 may be connected to a source of waste products to be transported. The waste products are drawn into the LTRV container 100 by using a vacuum pump 168. Additionally, the vacuum pump 168 may then be used to seal the LTRV container 100.

The base 120 comprises a mobility device 124 for use with a roll off truck 608 and base corner locks 122 to interact with other intermodal containers and intermodal transportation mechanisms. The base 120 may also be designed to rest on the ground and further comprises indentations 146 for forklift manipulation. The roof 130 comprises a large roof access opening 134 with a large roof access lid 136 to facilitate top loading of the LTRV container 100 and roof corner locks 132 to facilitate intermodal transport. On the anterior end 150 of the LTRV container 100 comprises a roll-off coupler 154 for interacting with a roll off hoist. A vacuum adaptor 158 allows a vacuum pump 168 to be coupled to the LTRV container 100 for vacuum loading. The posterior end 160 of the LTRV container 100 is substantially composed of the rear access door 162 that allows access to the interior of the tank 112.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

It will be understood by those skilled in the art that the LTRV container 100 may be used in a variety of circumstances and locations, and for purposes different from those specifically described here. For the reasons stated above, and for other reasons stated below which will become apparent to those skilled in the art upon reading and understanding the present application, there is a need in the art for the LTRV container 100.

### BRIEF DESCRIPTION OF FIGURES

A better understanding of the LTRV container 100 can be obtained when the detailed description of exemplary embodiment as set forth above is reviewed in conjunction with the accompanying drawings, in which:

FIG. 1 is a plan view of the side of a LTRV container 100;

FIG. 2 is a plan view of the posterior end 160 of a LTRV container 100;

FIG. 3 is a plan view of the anterior end 150 of a LTRV container 100;

FIG. 4 is a plan view of the roof 130 of a LTRV container 100;

FIG. 5 is a plan view of the side of a LTRV container 100 interfacing with a waste product source and a vacuum pump 168;

FIGS. 6A-E are a series of figures showing an exemplary embodiment of the LTRV container 100 being transported through multiple intermodal mechanisms;

FIGS. 7A-E are a series of figures showing an alternative exemplary embodiment of the LTRV container 100 being transported through multiple intermodal mechanisms; and

FIG. 8 is a flow chart illustrating the method in which the LTRV container 100 can be used in the transportation of items.

### DETAILED DESCRIPTION

In the following detailed description, reference is made to the accompanying drawings that form a part hereof, and in which is shown by way of illustration specific embodiments which can be practiced. The embodiments are described in sufficient detail to enable those skilled in the art to practice the embodiments. It is to be understood that other embodiments can be utilized and that logical, mechanical, and other changes can be made without departing from the scope of the embodiments. The following detailed description is, therefore, not to be taken in a limiting sense.

The LTRV container 100 is designed to collect waste products and hold them during transportation. In this disclosure, the term waste products is intended to include any materials that can be placed into and transported within the disclosed LTRV container 100, thus this includes solids, liquids, and gasses. In the exemplary embodiment, the LTRV container 100 can be used for collecting and transporting oilfield cuttings, such as NORM, for eventual disposal without the need for multiple containers in the transportation chain.

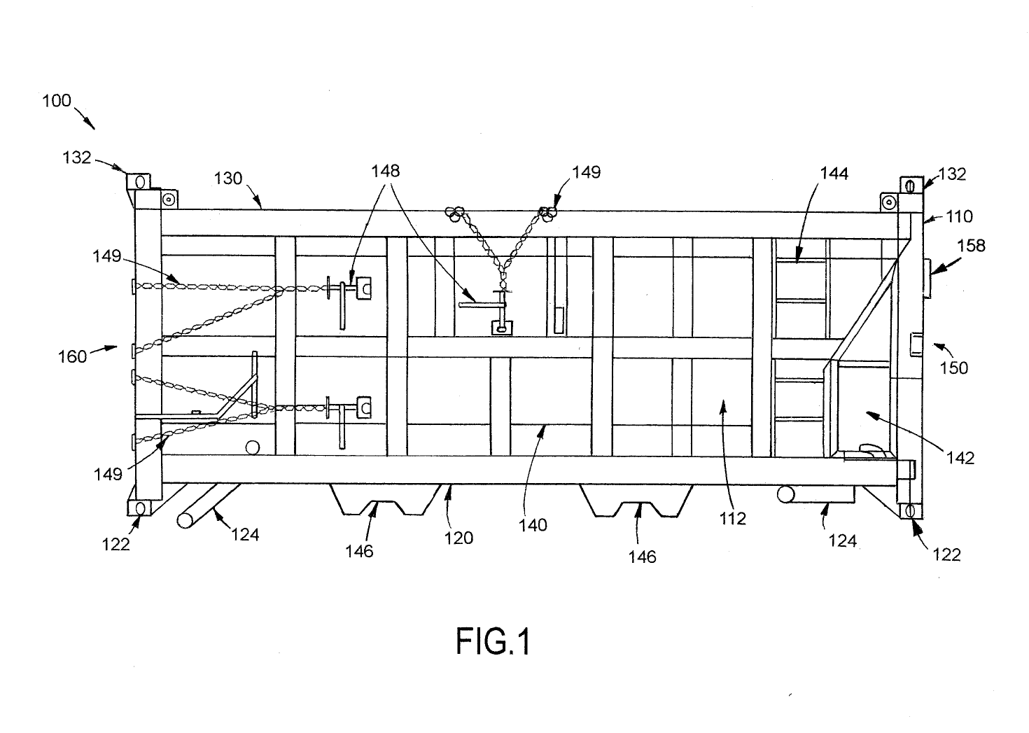

The exemplary embodiment of the LTRV container 100 shown in FIG. 1 comprises a tank 112 that is nested within and coupled to the container frame 110. The tank 112 occupies a substantial portion of the space within the container frame 110. In an exemplary embodiment, the container frame 110 is the load bearing structure that allows for the LTRV container 100 to interface with various forms of intermodal transportation. The tank 112 is the structure that holds the materials for transport. The container frame 110 and the tank 112 may integrated by any means know to those skilled in the art. In an exemplary embodiment, the container frame 110 may be constructed around a preexisting tank 112. In an alternative exemplary embodiment, the tank 112 and the container frame 110 may be fabricated at the same time from the same material. In the exemplary embodiment the interior of the tank 112 is curved to accommodate vacuum loading. Access to the tank 112 will be disclosed below. One skilled in the art will appreciate the LTRV container 100 may be configured differently without departing from the scope of the present disclosure and embodiments. In an alternative exemplary embodiment, the tank 112 may only partially reside with the container frame 110.

The container frame 110 and the tank 112 are built from plate material in an exemplary embodiment. Those skilled in the art will appreciate the plate material can be formed from any suitable material. In the exemplary embodiment steel plate material is used. The various sections are joined together in any suitable manner with the exception of the rear access doors 162 which are operational. In the exemplary embodiment these connections are made with welds while the rear access doors 162 are coupled by hinge fasteners 164.

The LTRV container 100 includes a first side wall 140a extending longitudinally. A second side wall 140b extends longitudinally and in parallel with the first side wall 140a. The posterior end 160 of the LTRV container 100 is dominated by the rear access door 162 that extends between the first side wall 140a and second side wall 140b and is perpendicular to both of them. The anterior end 150 of the LTRV container 100 is formed by a front wall 152 spaced in parallel to and on the opposite end from the rear access door 162. The LTRV container 100 also includes a roof 130 and a base 120.

The dimensions of the LTRV container 100 defined by the front wall 152, side walls 140, roof 130, base 120, and rear access door 162 are smaller than those of a standard intermodal container in an exemplary embodiment, but the volume of the area defined by the corner locks 122, 132 discussed below is equivalent to a standard intermodal container. These corner locks 122, 132 act as intermodal couplers, allowing the LTRV container 100 to be secured like any other intermodal container. Additionally, any other known means of securing an intermodal container for either storage or transport may be integrated into the LTRV container 100 without departing from the scope of this disclosure.

The LTRV container 100 in an exemplary embodiment further comprises roof corner locks 132 extending from the roof 130 and base corner locks 122 extending from the base 120. The locations of the base corner locks 122 and roof corner locks 132 correspond to the locations where they would be on an ISO standard container. As such, the distance between a roof corner lock 132 and the corresponding base corner lock 122 is the same as an ISO standard container. Additionally, the distance between the various roof corner locks 132 and base corner locks 122 is the same as if they were in a standard ISO container. Further, the base corner locks 122 act as supports to brace the LTRV container 100 relative to the ground in an exemplary embodiment.

The base 120 in an exemplary embodiment further comprises deployable mobility devices 124. The base 120 may interact with the ground as needed or may be configured to interact with a multitude of different environments. In an exemplary embodiment the mobility devices 124 are wheels. When in stowed configuration, these mobility devices 124 are kept flush against the base 120. When deployed, these mobility devices 124 allow the LTRV container 100 to be manipulated by a roll off truck 608. In an alternative embodiment the mobility devices 124 may be further deployed to allow the LTRV container 100 to be rolled like any other wheeled structure. In an alternative embodiment, the mobility devices 124 may be skids, casters, caterpillar track, or other devices known to those in the art. Additionally, indentations 146 are coupled to the base 120 to facilitate forklift movement.

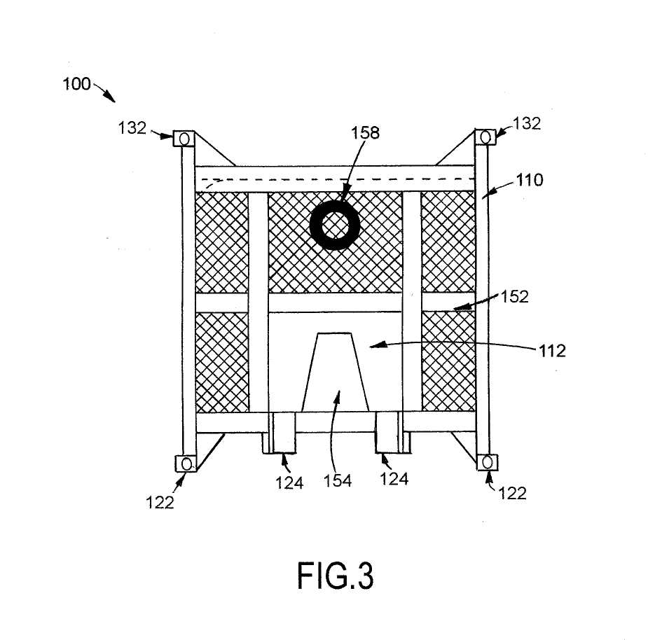

The front wall 152 in an exemplary embodiment shown in FIG. 3 comprises a roll-off coupler 154 and a vacuum adaptor 158. In the exemplary embodiment the roll-off coupler 154 is a piece of metal with an aperture that can accommodate a roll off winch. The roll-off coupler 154 has sufficient strength to resist deformation or breaking when the entire weight of the full LTRV container 100 is pulled by an external force, in this case a roll-off winch from a roll-off truck 608.

The first side wall 140a and second side wall 140b in an exemplary embodiment are substantially similar to each other in layout, with the second side wall 140b mirroring the first side wall 140a. On the first side wall 140a and second side wall 140b substantially close to the front wall 152 is a ladder 144 that facilitates access to the roof 130 of the LTRV container 100. A storage locker 142 is collocated to the ladder 144 to store needed equipment, such as chains and other restraints 149. Also located on the first side wall 140a and second side wall 140b are ratchets 148 that can be coupled to restraints 149 used to secure the rear access doors 162 and other openings in the LTRV container 100.

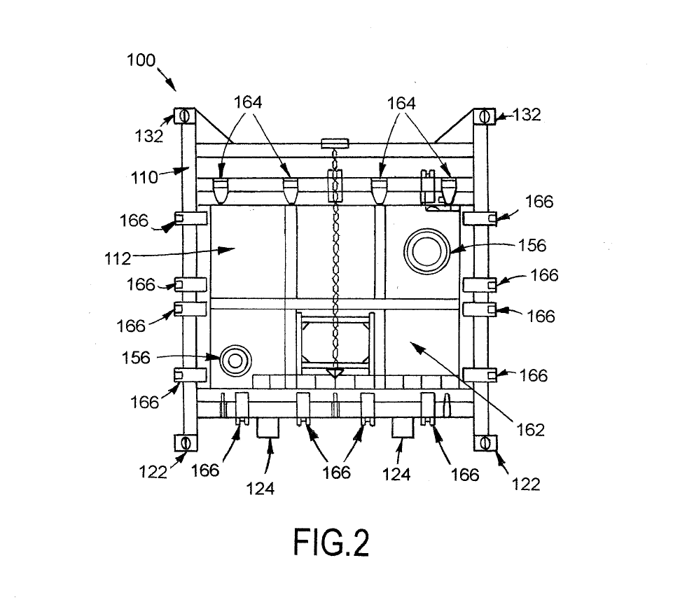

The posterior end 160 in an exemplary embodiment shown in FIG. 2 comprises the rear access doors 162. In the exemplary embodiment, the rear access doors 162 are coupled by hinge fasteners 164 to the rear sections of the roof 130. A plurality of projections 166 extend from the rear access doors 162 that are parallel to the surface of the rear access doors 162 and extend past the posterior end 160 of the side walls 140, and base 120. The projections 166 are capable of being coupled to restraints 149 or other means to the ratchets 148 to further secure the rear access doors 162. Additionally, there are standard access ports 156 leading to the interior of the tank 112 that may be used as needed.

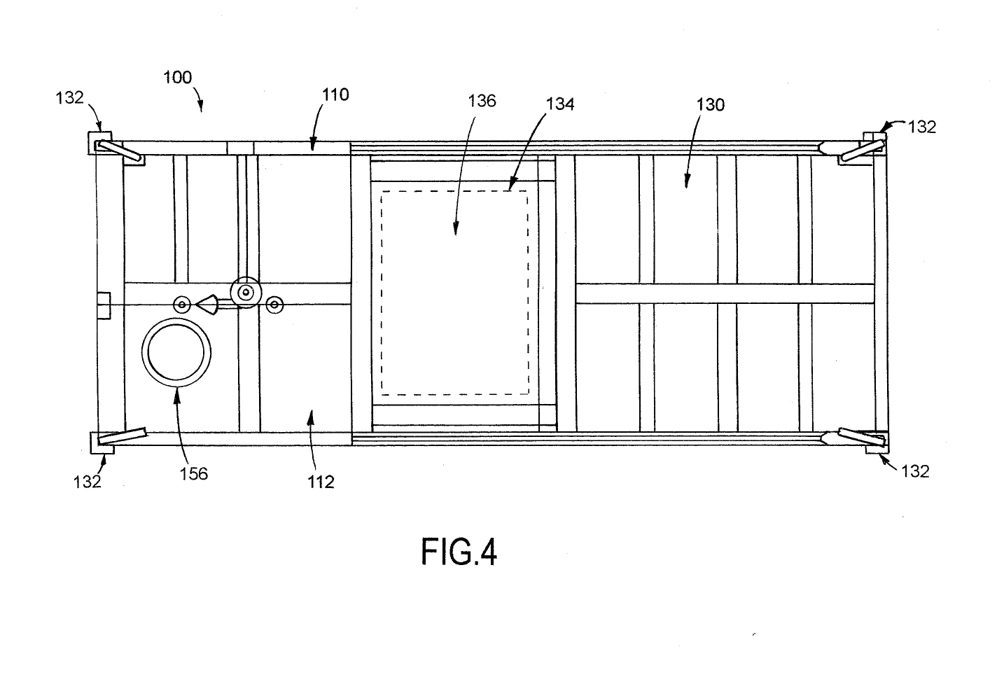

The roof 130 in an exemplary embodiment shown in FIG. 4 comprises roof corner locks 132, a standard access port 156, and a large roof access opening 134 covered by a large roof access lid 136. The large roof access opening 134 allows for loading, unloading, and for servicing the tank 112. The large roof access lid 136 may be removed, moved by slides, or pulled back on hinges depending on the embodiment in order to allow access to the interior of the tank 112 inside the LTRV container 100. When the large roof access opening 134 needs to be closed, the large roof access lid 136 may be secured in any manner known to those skilled in the art, including restraints 149 like chains. The design of the large roof access lid 136 enables a vacuum to be drawn within the tank 112 while maintaining the integrity of both the large roof access lid 136 and the LTRV container 100. The supports that reinforce the large roof access opening 134 and the large roof access lid 136 have both a cross sectional structure and moment of inertia that prevents the LTRV container 100 and/or the large roof access lid 136 from collapsing under vacuum. Additionally, the large roof access lid 136 assists in maintaining the integrity of the LTRV container 100 to allow stacking of containers. Additionally the roof corner locks 132 may be reinforced to facilitate crane 705 transportation. Alternatively, crane transportation couplers may be installed in a manner that does not interfere with the roof corner locks 132 to allow crane transportation.

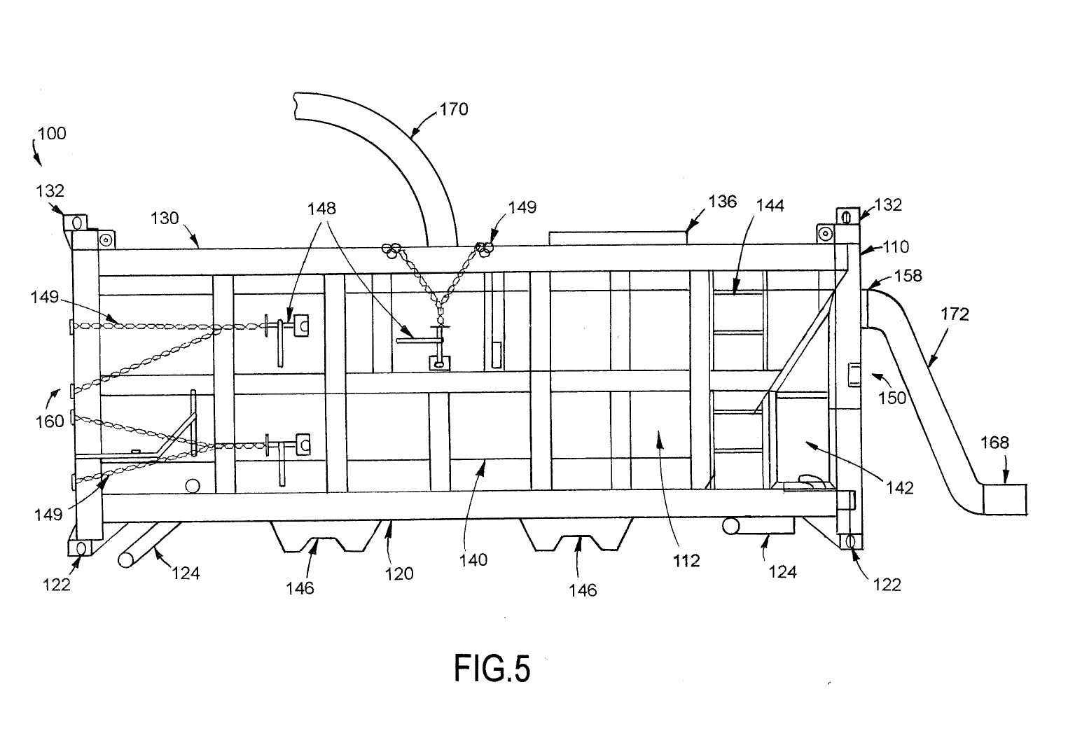

Loading of the LTRV container 100 may be accomplished by any means known to those skilled in the art, including vacuum loading as shown in an exemplary embodiment in FIG. 5. The vacuum pump 168 is connected to the LTRV container 100 by any means known to those skilled in the art. In an exemplary embodiment, a vacuum pump 168 is coupled to the vacuum adaptor 158 located in the front wall 152 by a hose 172. In an alternative exemplary embodiment, the vacuum pump 168 may be integrated into the LTRV container 100. Once the vacuum pump 168 is coupled to the LTRV container 100, then the LTRV container 100 can be connected to a source of material to be loaded into the LTRV container 100. A conduit 170 may be placed in the waste product storage location and in the large roof access opening 134. The vacuum pump 168 may then be activated, creating a vacuum in the LTRV container 100, causing the waste products to be pulled through the conduit 170 down to the LTRV container 100.

In an exemplary embodiment, when the source of the waste products is coupled to the LTRV container 100, the conduit 170 is connected to the large roof access opening 134. The diameter of the conduit 170 may be sufficient to allow the vacuum generated by the vacuum pump 168 to create and/or maintain a vacuum. In an alternative embodiment, an adaptor may be placed in the large roof access opening 134 to restrict the opening into the tank 112 to be just large enough to accommodate the conduit 170, creating a sufficient seal to allow the vacuum pump 168 to draw in the waste products.

In an alternative exemplary embodiment, the LTRV container 100 is loaded by an externally driven source, independent of the vacuum pump 168. In such an exemplary embodiment, the vacuum pump 168 may not be used to load the LTRV container 100, but may be used exclusively to create the vacuum seal when the large roof access lid 136 and all other openings are closed.

In addition to loading the LTRV container 100, a vacuum pump 168 allows the LTRV container 100 to be vacuum sealed. When all openings into the LTRV container 100 are closed, the vacuum pump 168 can continue to remove air and other gases from the tank 112 until such time as a vacuum exists. The vacuum pump 168 may then be decoupled from the LTRV container 100.

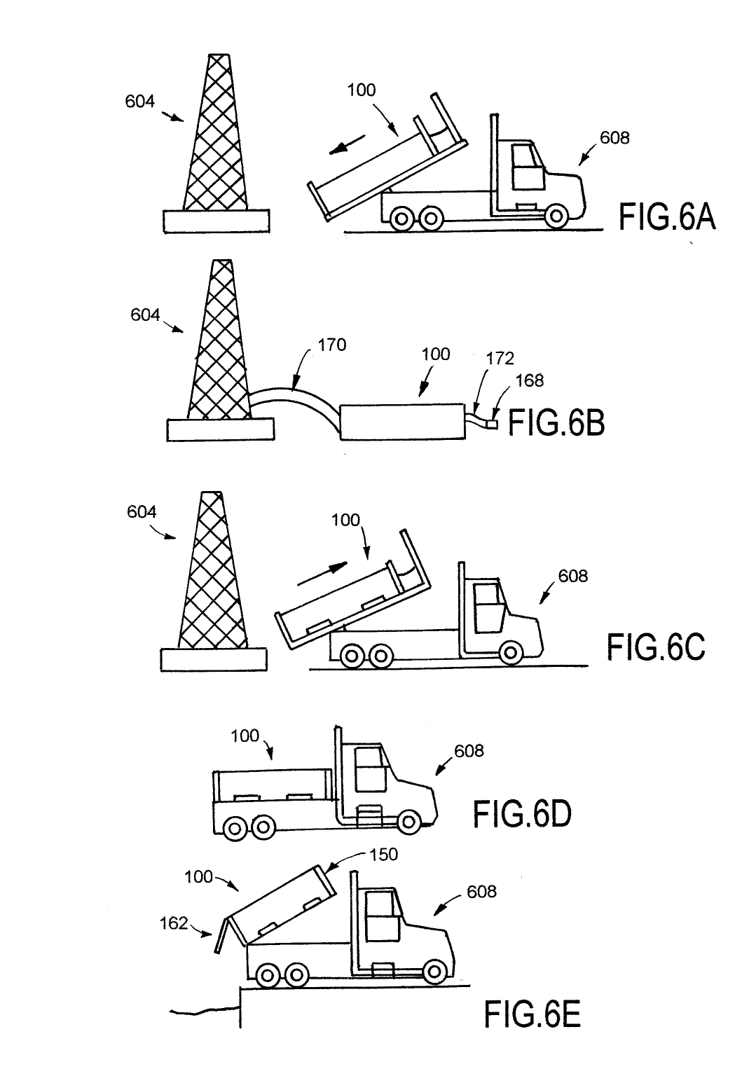

The LTRV container 100 allows for shipment of the contents through multiple modes of transportation and storage without having to open the LTRV container 100 or transfer the contents from one container to another. In an exemplary embodiment shown in FIGS. 6A-E, a LTRV container 100 is used to transport NORM from a land based oil well 604. During the drilling of the oil well, NORM may be released as consequence. A roll off truck 608 arrives at the oil well 604 and unloads the empty LTRV container 100 by means of a roll off hoist (FIG. 6A). The LTRV container 100 is coupled to the oil well 604 by a conduit 170 to collect NORM. The vacuum generated by the vacuum pump 168 coupled to the LTRV container 100 draws the NORM into the tank 112 (FIG. 2B). Operators seal the LTRV container 100 when it is full and vacuum seal it. The roll off truck 608 hoists the LTRV container 100 onto the bed of the roll off truck 608 where the LTRV container 100 is secured (FIG. 6C). The roll off truck 608 transports the LTRV container 100 (FIG. 6D) back to the disposal site where the LTRV container 100 is then unloaded and the contents disposed (FIG. 6E). The disclosed LTRV container 100 contains the NORM in a sealed environment from the site of collection to the site of disposal. At no point in the transportation process is the LTRV container 100 opened until disposal.

To offload the contents of the LTRV container 100, any opening may be used to have the contents removed. The rear access doors 162 may be opened and gravity may be used to remove the contents of the LTRV container 100 by raising the anterior end 150 of the LTRV container 100 to a sufficient height for all the contents to spill from the LTRV container 100. Once again there is no need to expose the contents of the LTRV container 100 during transport between the point of origin and the final destination.

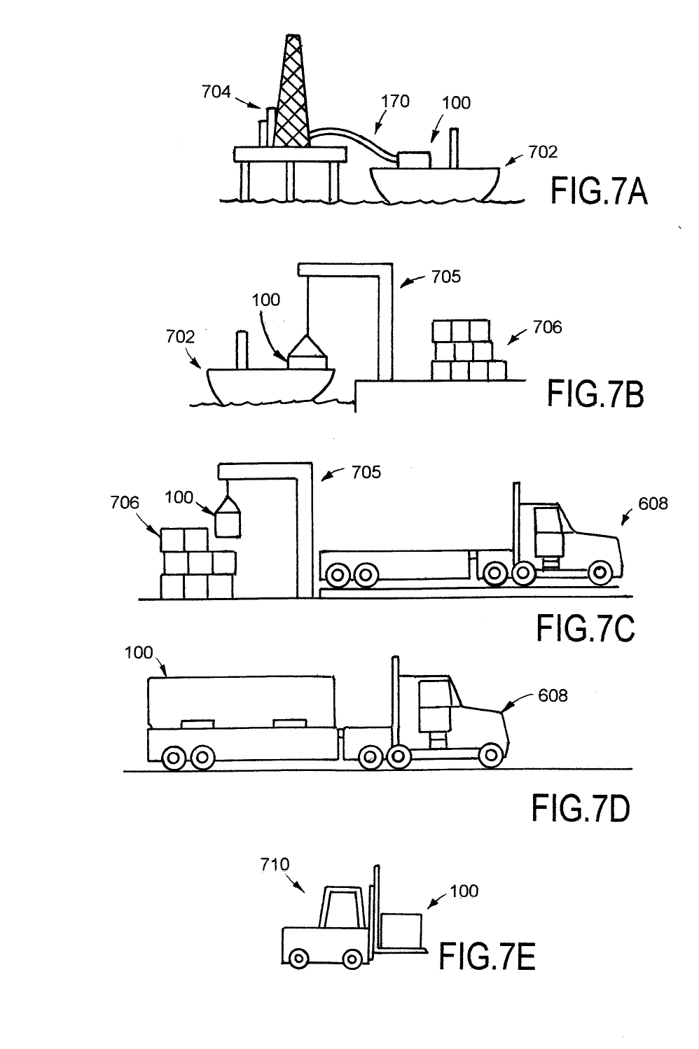

In an alternative exemplary embodiment shown in FIGS. 7A-E, the transportation of NORM from an offshore oil platform 704 will be discussed. In the example, the LTRV container 100 is on a ship 702 keeping station near an offshore oil platform 704. The LTRV container 100 is coupled to the location of the NORM collection with a conduit 170 (FIG. 7A). The vacuum generated by the vacuum pump 168 coupled to the LTRV container 100 draws the NORM into the tank 112. Operators close the LTRV container 100 when it is full and use the vacuum pump 168 to vacuum seal it. The ship 702 takes the LTRV container 100 to a port where it is offloaded to the dock by crane 705 and placed in a stack 706 of other intermodal containers (FIG. 7B) in any location allowable by the applicable intermodal standards. After a time, a crane 705 places the LTRV container 100 onto a roll-off truck 608 where it is secured for transport (FIG. 7C). The roll-off truck 608 then proceeds to a waste disposal site (FIG. 7D), where the LTRV container 100 is decoupled from the roll-off truck 608 and transported to the disposal location by forklift 710 (FIG. 7E). Operators at the disposal location then take the steps necessary to remove the NORM from the LTRV container 100.

In an additional example, the LTRV container 100 is used to transport chemicals. The LTRV container 100 may be loaded with chemicals via the standard access port 156. Once the LTRV container 100 is full, it is loaded onto a railroad car to be transported to a port for overseas shipment. The railroad car arrives at a port where the LTRV container 100 may be stored for a time to wait for a container ship. A reach stacker may place the LTRV container 100 in any location in accordance with international standards, either isolated or placed in stacks. The LTRV container 100 may be at any point in the stack, including the base of the stack per ISO standards. Once the container ship arrives, the reach stacker will place the LTRV container 100 adjacent to a crane 705, which will attach to the LTRV container 100 and place it in the container ship. Once the container ship arrives at the destination port, the LTRV container 100 may be unloaded and transported as previously disclosed.

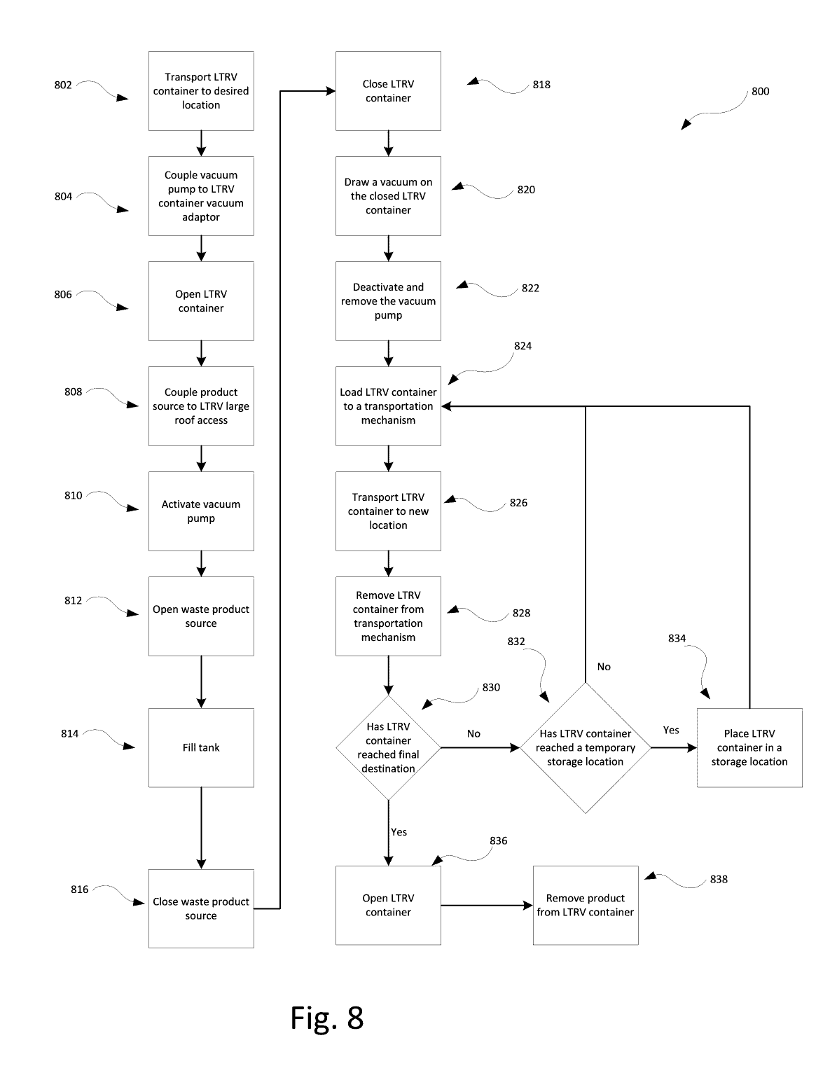

While previously disclosed examples illustrated specific methods of use of the disclosed invention, the following methodology 800 shown in FIG. 8 illustrates a more expansive view of how the LTRV container 100 may be used. The LTRV container 100 is transported to the location where the waste products are to be collected (step 802). A vacuum pump 168 is connected to the vacuum adaptor 158 (step 804). The LTRV container 100 is opened, allowing access to the interior of the tank 112 (step 806). The source of the waste products to be transported is then coupled to the LTRV container 100 (step 808). The vacuum pump 168 is activated (step 810), creating a vacuum in the tank 112. The source of the waste products is opened up (step 812), allowing the vacuum to draw the waste products into the tank 112. Over time, the tank 112 will be filled (step 814). The source of the waste products is then closed off (step 816), and the LTRV container 100 is closed (step 818). With openings closed, the vacuum pump 168 draws a vacuum until all the air is removed from the tank 112 (step 820). The vacuum pump 168 is then deactivated and decoupled (step 822). The LTRV container 100 is then loaded onto an intermodal transportation mechanism (step 824) and transported to a new location (step 826). At the new location, the LTRV container 100 is removed from the transportation mechanism (step 828). If the LTRV container 100 has not reached its final destination (step 830), and is being placed in a storage location (step 832), the LTRV container 100 is placed in a storage location (step 834) until it is loaded on a new transportation mechanism (step 824). If the LTRV container 100 has not reached its final destination (step 830), and is not being placed in a storage location (step 832), the LTRV container 100 is placed on a new transportation mechanism (step 824). If the LTRV container 100 has reached its final destination (step 830), the LTRV container 100 is opened (step 836) and unloaded (step 838).

Due to the potentially volatile nature of the contents of LTRV containers 100, there exists a need to verify the vacuum seal at various points in transit. One example would include the use of digital dosimeters located at various locations on the outside of the LTRV container 100 to provide an indication of any potential radiation leakage. These could be supplemented by film dosimeters as a redundancy. In an alternative embodiment, weight sensors could be installed in the base 120 of a LTRV container 100 to monitor the weight of said LTRV container 100 to determine if materials have been added or removed. The weight monitor embodiment may also include sensors that can determine if additional weight has been added by stacking of additional containers above the LTRV container 100 in question. In a further alternative embodiment, a gas detector may be used to determine if any hazardous gasses have started to escape from the LTRV container 100. Other possible safety features are known to those skilled in the art and are within the scope of this disclosure. Additionally, these safety detectors may be connected to a communication device that can provide remote alerts to the LTRV container 100 handler or the owner.

While the exemplary embodiments disclosed in this specification are rectangular, it is understood that the invention may be in any shape without departing from the scope and spirit of the invention. Additionally, while ISO standards have been used in exemplary embodiments, any accepted set of standards for intermodal containers are applicable with this disclosure.

One of ordinary skill in the art will appreciate that embodiments provide improved portable storage containers adapted for storage of products at drilling sites for oil and gas wells. Although specific embodiments are illustrated and described herein, it will be appreciated by those of ordinary skill in the art that any arrangement which is calculated to achieve the same purpose can be substituted for the specific embodiments shown. This specification is intended to cover any adaptations or variations of embodiments. For example, although described in terms of the specific embodiments, one of ordinary skill in the art will appreciate that implementations can be made in different embodiments to provide the required function. In particular, one of skill in the art will appreciate that the names and terminology are not intended to limit embodiments. Furthermore, additional apparatus can be added to the components, functions can be rearranged among components, and new components corresponding to future enhancements and future physical devices used in embodiments can be introduced without departing from the scope of embodiments. The terminology used in this application is intended to include all environments and alternatives which provide the same functionality as described herein.

What is claimed is:

1. A container, comprising:
a. a frame;
b. a tank at least partially surrounded by said frame;
c. an opening in said tank to facilitate loading of said tank; and
d. at least one of:
i. at least one intermodal coupler coupled to said frame;
ii. at least one deployable mobility device coupled to said frame; and
iii. at least one roll off hoist element coupled to said frame.

2. The container of claim 1, further comprising:
a. a large roof access opening located in said tank; and
b. a large roof access lid detachably coupled to said large roof access opening.

3. The container of claim 1, wherein said opening further comprises:
a. a large roof access opening located in said tank; and
b. a large roof access lid detachably coupled to said large roof access opening.

4. The container of claim 3, further comprising a vacuum adaptor capable of coupling said tank to a vacuum pump.

5. The container of claim 4, wherein said vacuum pump is capable of generating sufficient suction to draw into said tank through said opening at least one of:
a. liquids; and
b. solids of dimensions small enough to enter said opening.

6. The container of claim 5, wherein said large roof access lid when coupled to said large roof access opening allows a vacuum to be maintained within said tank.

7. The container of claim 6, where coupling of said large roof access lid to said large roof access opening allows said vacuum pump to create a vacuum sealed container.

8. The container of claim 1, wherein said container is dimensioned to be transported by at least one of the following:
a. railroad car;
b. flatbed truck;
c. container ship;
d. roll off truck;
e. forklift; and
f. reach stacker.

9. The container of claim 1, further comprising:
a. at least one fastener;
b. wherein said at least one fastener can couple to a second at least one fastener on a second container.

10. The container of claim 9, wherein said second container may be placed atop said container and coupled together via said at least one fastener and said second at least one fastener.

11. The container of claim 1, further comprising a rear access door to allow access the interior of said tank.

12. The container of claim 1, wherein said roll off hoist element may be coupled to a winch allowing at least one of the following:
a. said container to be loaded onto a roll off truck; and
b. said container to be unloaded from said roll off truck.

13. The container of claim 1, wherein said container is dimensioned for at least one of intermodal transportation or intermodal stacking.

14. The container of claim 13, wherein intermodal transportation is facilitated by said at least one intermodal coupler.

15. A system for disposal, comprising:
a. a container capable of receiving a product; and
b. at least one transportation device capable of transporting said container;
c. wherein said container is closed before it is transported; and
d. wherein said container remains closed until it reaches a delivery site.

16. The system of disposal of claim 15, wherein said container may be transported by a plurality of at least one transportation device in series.

17. The system of disposal of claim 15, wherein said container is capable of maintaining a vacuum when closed.

18. A method for disposal, comprising:
a. placing a container in proximity to a product generating station;
b. loading products from said product generation station into said container;
c. closing said container;
d. transporting said container to a delivery site;
e. opening said container at said delivery site; and
f. removing said products;
g. wherein said container may be transported by at least one transportation mechanism.

19. The method of claim 18, wherein said container is not opened until said container reaches said delivery site.

20. The method of claim 18, wherein transporting said container to said delivery site comprises:
a. loading said container on a first at least one transportation mechanism;
b. transporting said container to a first location using said first at least one transportation mechanism;
c. unloading said container from said first at least one transportation mechanism;
d. loading said container on a second at least one transportation mechanism;
e. transporting said container to a second location using said second at least one transportation mechanism; and
f. unloading said container from said second at least one transportation mechanism.
